(19) United States
(12) Patent Application Publication
(10) Pub. No.: US 2016/0069331 A1
(43) Pub. Date: Mar. 10, 2016

(54) Nitinol Heat Engine with Mechanical Storage Mechanism

(71) Applicants: Joseph Lawrence Kellogg, Moultonborough, NH (US); Mingming Guo Kellogg, Moultonborough, NH (US)

(72) Inventors: Joseph Lawrence Kellogg, Moultonborough, NH (US); Mingming Guo Kellogg, Moultonborough, NH (US)

(21) Appl. No.: 14/476,878

(22) Filed: Sep. 4, 2014

(51) Int. Cl. F03G 7/06

(52) U.S. Cl. CPC F03G 7/065

(57) ABSTRACT

A generator which uses one or more harvesting modules, each consisting of one or more nitinol elements, to harvest low grade thermal energy, converting it into high grade mechanical energy. The mechanical energy decoupled from the power generator by means of a mechanical energy storage mechanism, a mechanism capable of summing successive cycles, and a control mechanism. Stored mechanical energy is then utilized when needed.

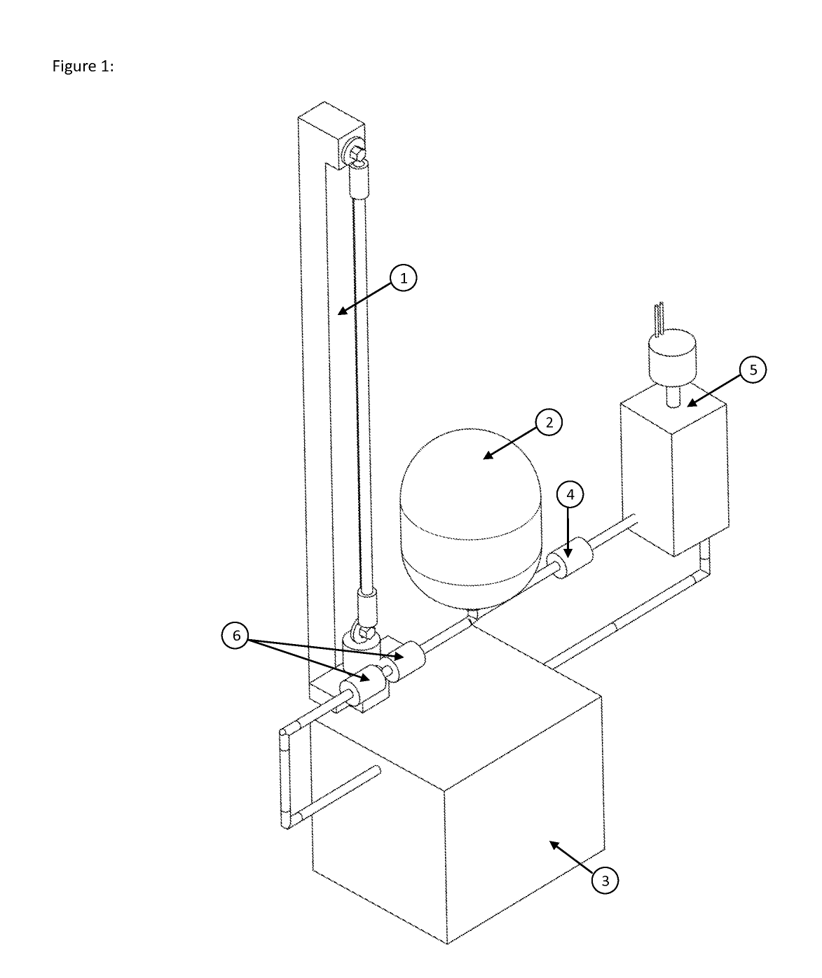

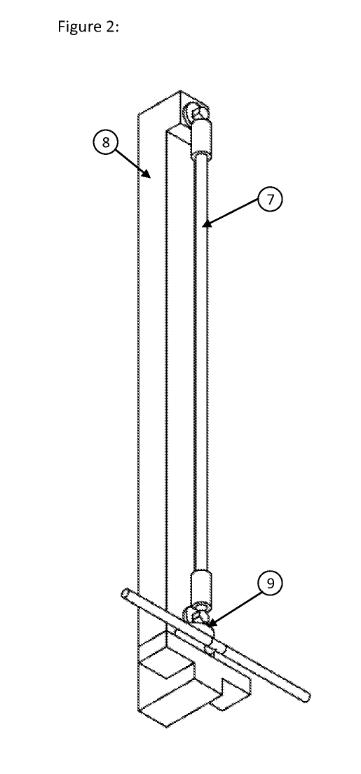

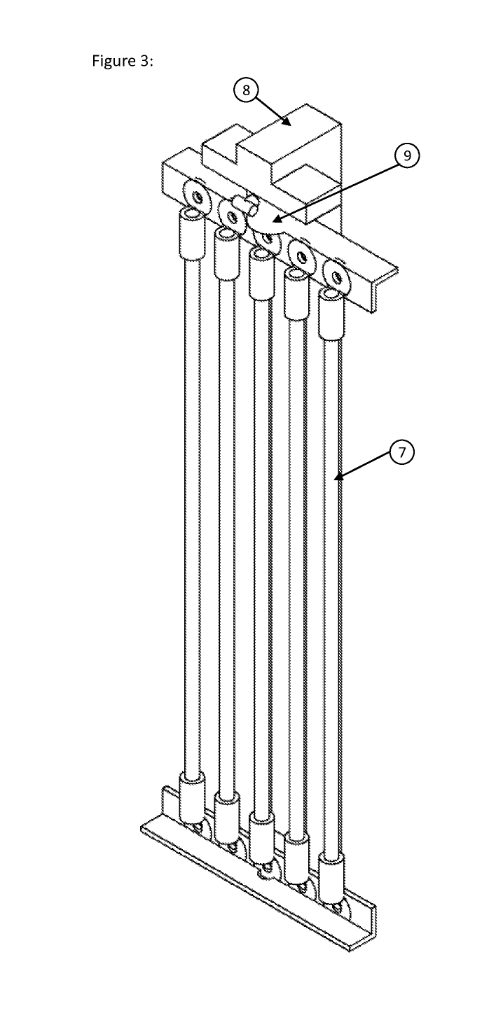

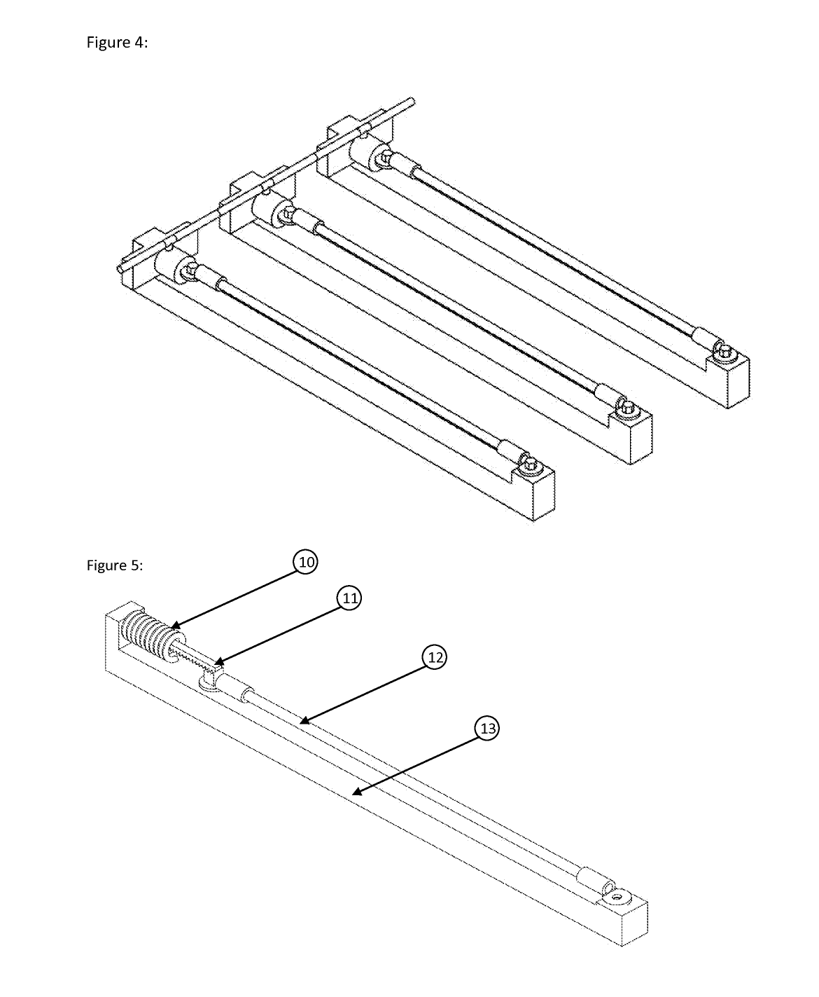

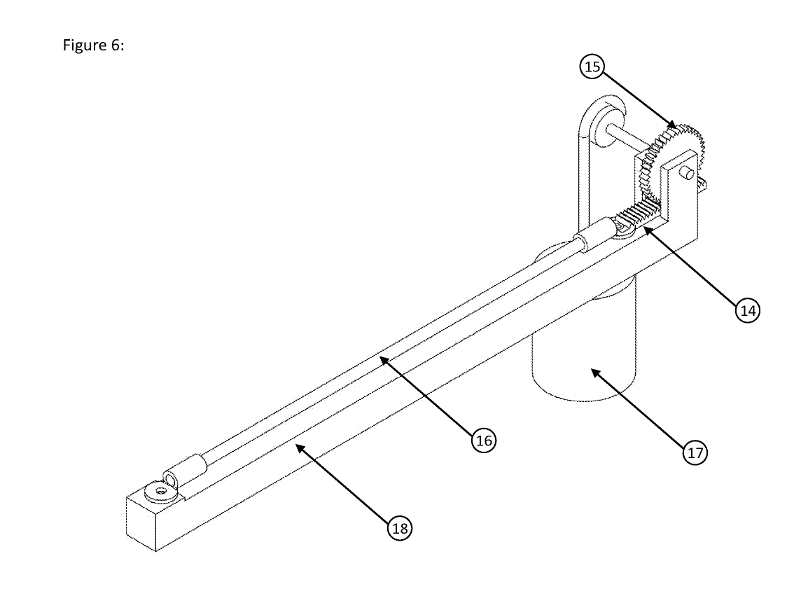

### REFERENCES CITED

| 8,522,545 B2 | Tice | Sep. 3, 2013 |
|---|---|---|
| 6,226,992 B1 | Kutlucinar | May 8, 2001 |
| 5,442,914 | Otsuka | Aug. 22, 1995 |
| 5,279,123 | Wechsler | Jan. 18, 1994 |
| 4,563,876 | Banks | Jan. 14, 1986 |
| 4,450,686 | Banks | May 29, 1984 |

### NON-PATENT DOCUMENTS

The Proceedings of the Nitinol Heat Engine Conference. Naval Surface Weapons Center, 1978.

### PRIOR ART

The field that pertains to the present invention is that of heat engines, more particularly, a nitinol powered heat engine which produces a linear output for the purpose of doing work.

Nitinol is one of several alloys that are known as either shape memory alloys (SMA) or thermoelastic materials. SMA's work because of the presence of multiple solid state phases or crystal structures that have dramatically different properties. Usually, one structure will have bonds that can rotate easily without being broken and the other will be very rigid. The existence of these two structures allow for a restoration of an apparently plastic deformation just by changing the temperature of the material. Said in other words, it converts low grade thermal energy into high grade mechanical energy. Clearly, potential applications for this are nearly endless.

SMA's are frequently used in the robotics, medical, and power generation. Of greatest interest to the authors is the previous work in power generation. Among previous work in power generation, the SMA of choice tends to be nitinol or one of its ternary alloys. By changing the chemical composition of the nitinol, the transition temperature can be anywhere from −100 degrees Celsius to more than 160 degrees Celsius with a thermal hysteresis ranging from eleven to more than one hundred degrees Celsius. This is very advantageous for the purposes of using nitinol to generate electricity because an Antarctic winter can observe temperatures below −50 degrees Celsius and certain deserts will observe temperatures as high as 80 degrees Celsius in direct sunlight. Therefore, this one material can cover all of the possible temperatures found on earth.

In ‘The Proceedings of the Nitinol Heat Engine Conference’, an early discussion on the feasibility of using SMA's to generate power, nitinol engines are stated as having a thermal efficiency of 1-4% and a Carnot efficiency in the region of 20-25%. Efficiencies in the single digit range are disheartening, especially since power plants can have efficiencies over 40%. However, because SMA's work over a relatively small temperature change (several degrees Celsius rather than hundreds or thousands of degrees Celsius), low grade heat which would otherwise be considered waste can be used to generate high grade power. This revenue from refuse makes SMA based heat engines quite desirable, despite the high material costs and low efficiencies.

It has been well established that nitinol works best in pure tension. It is because of this that Banks created his linear output nitinol engine. Banks also disclosed a nitinol engine consisting of only one element held in tension to simplify design as much as possible. While it is relatively simple to harness the linear motion produced by the nitinol, the difficulty here is that nitinol creates a sudden burst of energy and most systems need a continuous source of energy. Additionally, the system may not need the energy when it is generated. Therefore, it is important to decouple the nitinol energy harvesting mechanism from the power generation mechanism. This is best done with a mechanical storage system, thus avoiding the losses associated with converting energy from one form to another.

Recently, Tice disclosed a heat engine which utilizes a conductive path to heat the nitinol. As with the other creations, this requires power consumption upon generation. Otsuka disclosed an engine with multiple stacks of conical disc-springs constructed of SMA. However, Otsuka's engine was not modular, nor did it make provision for a storage mechanism—requiring power to be used when generated. Kutlucinar also disclosed an engine capable of converting low grade heat into mechanical energy utilizing multiple shape memory springs. However, he fell short of realizing the potential of a modularized engine and failed to include a mechanical energy storage mechanism.

Wechsler's team was another to disclose a nitinol heat engine for the purpose of recovering waste heat. His design utilized nitinol springs held in tension which could be heated and cooled individually to turn a crankshaft. However, Wechsler's engine failed to attain the benefits of modularization nor did it provide a means of decoupling the generation from use.

To the best knowledge of the authors, no one has created such a system where the nitinol heat engine is modularized and decoupled from the power generation by means of a mechanical energy storage mechanism working in conjunction with a mechanism capable of summing successive cycles and a control mechanism.

### DESCRIPTION OF THE INVENTION

There are three primary areas where the invention at hand is an improvement over prior art. The first is that of improving the mechanical efficiency by reducing the quantity of moving parts—and therefore frictional and other losses. The second is the decoupling of the energy harvesting mechanism from the power generation mechanism. This allows the system to both generate energy at an even, continuous rate rather than the discretized energy generated by the shape memory effect. Additionally, it allows energy to be utilized when desired rather than being enslaved to the cycle of the shape memory effect. The third improvement is in modularizing the energy harvesting mechanism.

Modularized harvesting mechanisms permit simplified expansion and reconfiguration by the end user of the engine as well as the use of multiple transition temperature SMA elements. An example of a benefit of utilizing modules with different transition temperatures would be to place lower transition temperature elements downstream in a heat recovery cycle to optimize the amount of heat extracted from the heat recovery cycle.

In the area of improving mechanical efficiency through simplifying the mechanical design, one of the simplest forms of a linear, mechanical device is a hydraulic cylinder. All contact surfaces are kept well lubricated by the hydraulic fluid, thus minimizing frictional losses. Additionally, as long as a low viscosity hydraulic fluid is used and the hydraulic lines are of sufficient size, minimal energy is lost through fluid friction. Other mechanisms which work well in this area include gear trains, rack and pinion gears, levers, etc.

It is necessary to have a method of summing successive cycles so that the SMA element can cycle numerous times, charging the storage mechanism. Some commonly recognized mechanisms that accomplish this include ratchets, check valves, and clutches. Each of these mechanisms only permit work flow in one direction and allow for a relatively effortless reset cycle. The effortless reset cycle improves the efficiency of the energy harvesting cycle because less energy is lost to system components.

In the area of decoupling the energy harvesting mechanism from the power generation system, a few options exist for storing mechanical energy and fewer still that are near lossless. The near lossless methods of storing mechanical energy are 1. gravity, 2. springs, 3. fluid pressure, 4. flywheels, and 5. magnets. Hydraulic accumulators are an adaptation of the first three mechanisms for the purpose of storing pressurized hydraulic fluid. They typically use either an elevated weight, spring, or gas filled bladder to maintain pressure on the hydraulic liquid. Flywheels differ from the other four forms of energy storage in that they store kinetic energy rather than potential energy. This is useful for converting the discrete nature of the shape memory effect into a more continuous stream of available work. Magnets can be used to store potential energy by bringing same poles closer together so that they create an oppressive force.

The final decoupling of the shape memory cycle from the point of use comes from the use of a control mechanism. This mechanism may be in the form of a valve for hydraulics or it might be in the form of a brake or clutch for other mechanical systems. A good, controllable control mechanism permits the use of partial power, not just a simple on/off factor.

Modularization brings many benefits to the table. One benefit is the flexibility and scalability of the end design. In the field of the SMA heat engine, the modularized energy harvesting mechanism permits the use of multiple transition temperature nitinol elements to broaden the effectiveness of the energy harvesting. Additionally, having a modularized energy harvesting mechanism makes it relatively easy for the end user to scale the harvesting to meet their needs. This is especially true for cases where the need for energy harvesting changes after it is initially installed. For these cases, all that is required is to add or subtract the necessary quantity of modules rather than purchase a whole new generation unit.

### DESCRIPTION OF A PREFERRED EMBODIMENT

Modularization allows a tremendous amount of flexibility in design. The preferred embodiment of the invention at hand, consists of one or more harvesting modules. Each module consists of one or more nitinol elements and a method of transferring the energy harvested by the nitinol elements to the storage mechanism. The storage mechanism may be modularized on each harvesting module or it may be globalized so that all of the modules store their energy in one storage mechanism.

In the preferred embodiment utilizing hydraulics as the means of energy transfer and storage, one or more nitinol wires are affixed at one end to the rigid support member and attached to the free end of a hydraulic cylinder at the other end such that when the shape memory effect occurs, the wires contract, extending the hydraulic cylinder. Upon cooling, a biasing force—generally in the form of a spring—stretches the nitinol wire and returns the hydraulic cylinder to the retracted position. This cycle pumps hydraulic fluid into the hydraulic accumulator, which may be located in any convenient location, for storage until needed. When work is needed, the valve is opened, controlling the release of oil into the system needing work.

In the preferred embodiment utilizing a ratchet mechanism as the means of energy transfer and storage, the nitinol wires are fixed at one end to the rigid support member as before. The free end of the nitinol element is attached to the ratchet mechanism so that each time the nitinol wire cycles, the ratchet mechanism moves a little further. The motion of the ratchet mechanism can be either linear or rotary. The ratchet mechanism can be attached to a spring to gradually compress the spring. The ratchet mechanism can also be made such that each time it is cycled, a mass is elevated. The potential energy stored in the spring can be released when needed, providing work output, through the use of clutches, brakes, etc. Upon cooling, a biasing mechanism stretches the nitinol wire and resets the ratcheting mechanism for the next cycle.

In the preferred embodiment utilizing a rack and pinion gear as the means of energy transfer, the nitinol wires are fixed at one end to the rigid support member as before. The free end of the wires is attached to the rack gear such that, when the wire contracts, the rack gear turns the pinion gear, creating rotary motion. The work transmitted by rotary motion can be stored through the use of an elevated mass, flywheel, spring, etc. When needed, work can be extracted from these storage mechanisms through the use of brakes, clutches, etc.

In the interest of improving efficiency by minimizing the number of wires, and thereby eliminating loss due to property differences caused by fluctuation in the chemical content and thermomechanical histories of the wires, the energy transfer mechanism can be sized accordingly to minimize the number of wires on each cylinder. In the interest of reducing the cycle time by minimizing the radius of the wire, a multiplicity of wires may be attached to each module.

Multiple harvesting modules may be connected together to expand the system. The modules may have different transition temperatures to widen the temperature range over which the generator can harvest useful energy or to accommodate smaller wires, thus allowing the generator to be more responsive to temperature change. Having a modularized harvesting system allows the end user to add or subtract the number of modules needed to tailor the generator to their needs.

### BRIEF DESCRIPTION OF THE FIGURES

Figure one shows a preferred embodiment of the invention consisting of a harvesting module (1), hydraulic accumulator (2) which stores the mechanical energy in the form of pressurized oil until needed, and reservoir (3). A control valve (4) controls the flow of oil so that work is produced on demand for the system being powered (5). Check valves (6) provide the summing of successive cycles as high pressure fluid can only travel into the accumulator (2) and low pressure fluid can only be drawn in from the reservoir (3). Figure two shows an excerpted harvesting module, complete with one nitinol wire (7), rigid support member (8), and hydraulic cylinder (9). The preferred location of the biasing mechanism in this case is inside of the hydraulic cylinder. Figure three shows a harvesting module with multiple nitinol wires (7), the rigid support member (8), and hydraulic cylinder (9). Figure four shows three harvesting modules connected in series. The modules may be connected either in series or in parallel to obtain optimal results.

Figure five shows a preferred embodiment utilizing a spring (10) to store the energy and a ratchet mechanism (11) to transfer the energy from the nitinol wire (12). The whole system is held in place by the rigid support member (13). Figure six shows a preferred embodiment utilizing a rack gear (14) and a pinion gear (15) to transfer energy from the nitinol wire (16) to elevate the mass (17). The system is held in place utilizing a rigid support member (18). The preferred embodiment of the biasing mechanism for the embodiments shown in figures five and six is a pneumatic bladder or cylinder built inside of the rigid support member. The end of the bladder is attached to the free end of the nitinol wire, providing the extension force needed to reset the shape memory cycle.

1. A shape memory alloy (SMA) heat engine consisting of one harvesting module and a means of storing mechanical energy.

2. A SMA heat engine consisting of multiple harvesting modules and a means of storing mechanical energy.

3. The SMA heat engine mentioned in claim 1 where the SMA is nitinol.

4. The nitinol mentioned in claim 3 is composed of 54.5-57% weight nickel and the balance is titanium.

5. The nitinol mentioned in claim 3 has 0-20 atomic % of nickel replaced by copper.

6. The harvesting module mentioned in claim 1 consisting of one SMA element, a rigid support member, and a biasing mechanism.

7. The harvesting module mentioned in claim 1 consisting of multiple SMA elements, a rigid support member, and a biasing mechanism.

8. The harvesting module mentioned in claim 1 having a mechanism capable of summing multiple, successive cycles.

9. The harvesting module mentioned in claim 1 having a mechanism capable of converting linear to rotary motion.

10. The SMA heat engine mentioned in claim 1 having a means for releasing the stored mechanical energy when needed.

11. The SMA heat engine mentioned in claim 2 where the nitinol members of different harvesting modules have different transition temperatures.
